(19) United States
(12) Patent Application Publication
(10) Pub. No.: US 2021/0048971 A1
(43) Pub. Date: Feb. 18, 2021

(54) INFORMATION PROCESSING APPARATUS, INFORMATION PROCESSING SYSTEM, AND INFORMATION PROCESSING METHOD

(71) Applicant: Mari TATEZONO, Tokyo (JP)

(72) Inventor: Mari TATEZONO, Tokyo (JP)

(21) Appl. No.: 16/986,356

(22) Filed: Aug. 6, 2020

(30) Foreign Application Priority Data
Aug. 14, 2019 (JP) 2019-148954

(51) Int. Cl. G06F 3/14; H04L 29/06; G06F 3/0484

(52) U.S. Cl. CPC G06F 3/1454; G06F 3/0484; H04L 65/403

(57) ABSTRACT

An information processing apparatus includes circuitry to: cause a web browser of each of a plurality of communication terminals to display a web page including one or more images of a shared screen to be shared by the plurality of communication terminals; for each user of a plurality of users of the plurality of communication terminals, quantify writing content written by the user at the communication terminal with respect to at least one image of the shared screen into numerical data of the writing content; and output information based on the numerical data of the writing content for display.

### CROSS-REFERENCE TO RELATED APPLICATIONS

This patent application is based on and claims priority pursuant to 35 U.S.C. § 119(a) to Japanese Patent Application No. 2019-148954, filed on Aug. 14, 2019, in the Japan Patent Office, the entire disclosure of which is hereby incorporated by reference herein.

### BACKGROUND

### Technical Field

The present disclosure relates to an information processing apparatus, an information processing system, and an information processing method.

### Discussion of the Background Art

In the background conference system using such as groupware, participants and meeting materials are previously set for a conference to be held, to allow each participant to browse information related to the conference in advance. In such a conference system, information related to conferences can be shared, such that a user can obtain information on the participants and materials of any past conference from information stored in the groupware.

The information stored in such groupware, however, fails to provide information useful to presenters who shared materials in conferences, such as information on whether the participants have any interests in such materials.

### SUMMARY

Example embodiments include an information processing apparatus including circuitry to: cause a web browser of each of a plurality of communication terminals to display a web page including one or more images of a shared screen to be shared by the plurality of communication terminals; for each user of a plurality of users of the plurality of communication terminals, quantify writing content written by the user at the communication terminal with respect to at least one image of the shared screen into numerical data of the writing content; and output information based on the numerical data of the writing content for display.

### BRIEF DESCRIPTION OF THE DRAWINGS

FIG. 1 is a schematic diagram illustrating an overview of an information sharing system used in a meeting being conducted, according to an embodiment;

FIG. 2 is a diagram illustrating an example of an overview of a personal portal in the information sharing system;

FIG. 3 is a block diagram illustrating an example of a hardware configuration of a computer, according to an embodiment;

FIG. 4 is a block diagram illustrating an example of a hardware configuration of a smartphone, according to an embodiment;

FIGS. 5A and 5B (FIG. 5) are a block diagram illustrating an example of a functional configuration of a personal terminal and a content management server of the information sharing system, according to an embodiment;

FIGS. 6A, 6B, and 6C (FIG. 6) are an illustration of an example of data structure of a content management database (DB), according to an embodiment;

FIG. 7 is a table illustrating an example of a data structure of the degree of interest management DB;

FIG. 8 is a flowchart illustrating an example of an operation performed by the information sharing system, according to an embodiment;

FIG. 9 is an illustration of example patterns of distribution and acquisition of a capture image, according to an embodiment;

FIG. 10 is an illustration of an example of a user interface (UI) of the information sharing system, according to an embodiment;

FIG. 11 is a sequence diagram illustrating an example of an operation performed by the information sharing system, according to an embodiment;

FIG. 12 is a sequence diagram illustrating an example of an operation performed by the information sharing system, according to an embodiment;

FIG. 13 is a diagram illustrating an example of a capture image and a memo written on the capture image or a margin of the capture image;

FIG. 14 is a diagram illustrating an example of a capture image and a memo written on the capture image or a margin of the capture image;

FIG. 15 is a diagram illustrating an example of an amount of memo, which is an example of numerical data that quantifies the writing content that is extracted;

FIG. 16 is a diagram illustrating a display example of a personal portal screen, according to an embodiment;

FIG. 17 is a view illustrating a display example of a result display screen;

FIG. 18 is a view illustrating a display example of a result display screen.

FIG. 19 is a diagram illustrating an example of a capture image and a memo written on the capture image or a margin of the capture image;

FIG. 20 is a flowchart of an example of a process of displaying a result display screen when the number of capture images differs between participants, performed by the information sharing system, according to an embodiment; and

FIG. 21 is a schematic diagram illustrating an overview of an information sharing system used in a meeting being conducted, according to an embodiment.

### DETAILED DESCRIPTION

Embodiments of the present disclosure are described in detail below, with reference to the drawings. The description given hereinafter is of an example of an information sharing system used in a meeting, conference, seminar, lecture, class or the like. However, this is just an example, and the embodiments are applied to various kinds of information processing system. In the embodiments, in one example, all users are in the same room such as a conference room. In another example, users who are connected through a network are in physically separated rooms. A description is given hereinafter of an example in which the information sharing system according to the present embodiment is used in a meeting. In the following, the meeting and the conference may be used interchangeably.

### First Embodiment

Overview of Information Sharing System Used in Meeting:

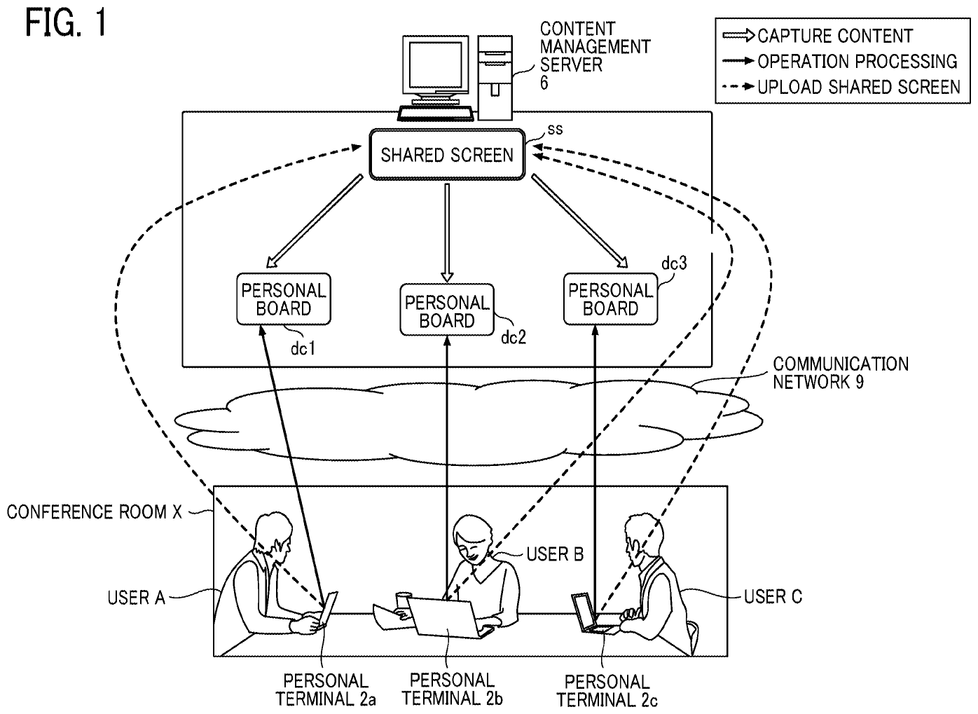

First, with reference to FIG. 1, an overview of an information sharing system according to the present embodiment is described. In the embodiment, a meeting is being held using the information sharing system. FIG. 1 is a schematic diagram illustrating an overview of the information sharing system used in a meeting being conducted, according to the present embodiment. FIG. 1 illustrates an example case in which a user A, a user B, and a user C who are in a conference room X of a company are conducting a remote meeting by using the information sharing system. In the conference room X, the user A uses a personal terminal 2a, the user B uses a personal terminal 2b, and the user C uses a personal terminal 2c. In the following description, the personal terminal 2a, the personal terminal 2b, and the personal terminal 2c are collectively referred to as simply a “personal terminal 2” or “personal terminals 2”, unless these terminals need to be distinguished from each other. Further, in the following, an example is described in which the user A is a presenter and the users B and the user C are attendees.

The personal terminal 2 is a computer that a user can use individually or exclusively and whose screen is viewed (browsed) by the user individually. The personal terminal 2 is not limited to being privately-owned. The personal terminal 2 may be public, private, non-profit, rental or any other type of ownership terminal in which a user may individually or exclusively use the terminal and whose screen is viewed by the user individually. Examples of the personal terminal 2 include, but not limited to, a laptop computer, a desktop personal computer (PC), a mobile phone, a smartphone, a tablet terminal, and a wearable PC. The personal terminal 2 is an example of a communication terminal (or an information processing terminal).

The personal terminal 2 is communicable with a content management server 6 through a communication network 9 such as the Internet. The communication network 9 is, for example, one or more local area networks (LANs) inside the firewall. In another example, the communication network 9 includes the Internet that is outside the firewall in addition to the LAN. In still another example, the communication network 9 further includes a virtual private network (VPN) and/or a wide-area Ethernet (registered trademark). The communication network 9 is any one of a wired network, a wireless network, and a combination of the wired network and the wireless network. In a case where the content management server 6 and the personal terminal 2 connects to the network 9 through a mobile phone network such as 3G, Long Term Evolution (LTE), 4G, the LAN can be omitted.

The content management server 6 is a computer functioning as a web server (or HTTP server) that stores and manages data of contents to be transmitted to the personal terminal 2. The content management server 6 includes a storage unit 6000 described below.

The storage unit 6000 includes storage locations (or storage areas) for implementing personal boards dc1 to personal board dc3, which are accessible only from each personal terminal 2. Specifically, only the personal terminal 2a, the personal terminal 2b and the personal terminal 2c can access a personal board dc1, a personal board dc2 and a personal board dc3, respectively. In the following description, the personal board dc1, the personal board dc2, and the personal board dc3 are collectively referred to as simply a “personal board dc”, unless these boards need to be distinguished from each other. In one example, the content management server 6 supports cloud computing. The “cloud computing” refers to internet-based computing where resources on a network are used or accessed without identifying specific hardware resources. The storage unit 6000 of the content management server 6 includes a storage location (or storage area) for implementing a shared screen ss described below.

The “personal board dc” is a virtual space generated in the storage location (or the storage area) in the storage unit 6000 of the content management server 6. For example, the personal board dc is accessible by using a web application having a function of allowing a user to view and edit contents with the Canvas element and JavaScript (registered trademark).

The “web application” refers to software used on a web browser application (hereinafter referred to as a “web browser”, in order to simplify the description). The web application is implemented by a program written in a script language such as JavaScript (registered trademark) that operates on the web browser and a program on a web server side, which operate in cooperation with each other. Further, the web application refers to a mechanism that implements such software. The personal board dc has a finite or an infinite area within the range of the storage area in the storage unit 6000. For example, the personal board dc may be finite or infinite both in the vertical and horizontal directions. In another example, the personal board dc may be finite or infinite in either the vertical direction or the horizontal direction.

The “shared screen ss” is a virtual space generated in the storage location (or the storage area) in the storage unit 6000 of the content management server 6. The shared screen ss has a function of holding content data that is uploaded by streaming from the personal terminal 2a of the user A, who is the presenter, until next content data is acquired. The shared screen ss is a computer screen such as an application screen. The shared screen ss is a capturing target of a capture image, as described below.

The personal board dc is an electronic space dedicated to each of users participating in the meeting. The personal terminal 2 of each user can access only the personal board dc dedicated to the corresponding user, which allows the corresponding user to view and/or edit (input, delete, copy, etc.) contents such as characters and images on the accessed personal electronic canvas.

The content management server 6 stores, for each virtual conference room, information (data) such as contents developed on the shared screen ss and the personal board dc in association with the corresponding virtual conference room. The virtual conference room is an example of a virtual room. Hereinafter, the virtual conference room is referred to as a “room”, in order to simplify the description. Thereby, even when the content management server 6 manages plural rooms, data of a content are not communicated over different rooms.

Each personal terminal 2 causes the web application operating on the web browser installed in the personal terminal 2 to access the contents of the personal board dc and the shared screen ss of the room in which the user participates. Thus, the meeting is held in a manner that is close to a meeting held in the real conference room.

The information sharing system, the user A, who is a presenter, causes a capture image of a content uploaded to the shared screen ss to be taken into the personal board dc of the users B and the user C, who are attendees, as a personal document, as described below.

Overview of Persona Portal in Information Sharing System:

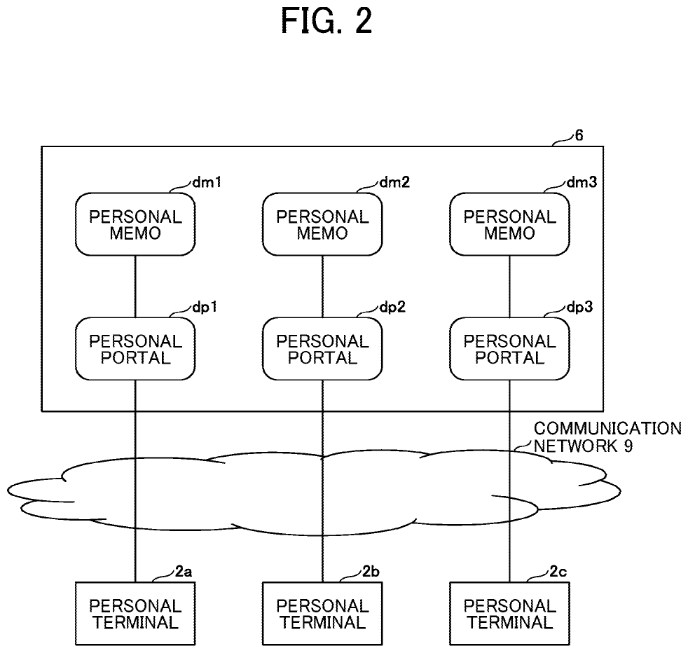

A description is now given of an overview of a personal portal, with reference to FIG. 2. FIG. 2 is a diagram illustrating an example of an overview of a personal portal in the information sharing system. The content management server 6 generates data for a personal portal screen dp1, a personal portal screen dp2, and a personal portal screen dp3 dedicated to the personal terminal 2a, the personal terminal 2b, and the personal terminal 2c, respectively, to cause the personal terminals 2 to perform display based on the generated data. In the following description, the personal portal screen dp1, the personal portal screen dp2, and the personal portal screen dp3 are collectively referred to a simply a “personal portal screen dp”, unless these portal screens need to be distinguished from each other.

The content management server 6 stores and manages a personal memo dm1, a personal memo dm2, and a personal memo dm3, which are contents (contents written by the user) edited on the personal board dc1, the personal board dc2, and the personal board dc3, respectively. In the following description, the personal memo dm1, the personal memo dm2, and the personal memo dm3 are collectively referred to as simply a “personal memo dm”, unless these personal memos need to be distinguished from each other. Each user accesses the personal portal screen dp dedicated to each personal terminal 2, to control display of a list of meetings in which the user who operates the corresponding personal terminal 2 has participated.

The user can cause the personal memo dm of each meeting and reference information of the meeting to be displayed from a list of meetings displayed on the personal portal screen dp, as described below. Thus, for example, when a user wants to look back contents of meetings, the user can instruct to display the personal memo dm of a desired meeting and the reference information of the desired meeting in a simple manner.

Further, each user accesses the personal portal screen dp dedicated to each personal terminal 2, to display a result display screen as described below, from a list of meetings in which the user who operates the corresponding personal terminal 2 has participated. The result display screen is an example screen, which provides information to be used for estimating the degree of user's interest with respect to the capture image. For example, the writing content such as lines, marks, or handwritten characters written by each user, can be quantified for each capture image. Based on comparison of numerical data obtained by quantifying, the information to be used for estimating the degree of user's interest may be generated. In another example, the result display screen may display the degree of user's interest, based on estimation result obtained by such comparison.

Further, each user accesses the personal portal screen dp dedicated to each personal terminal 2, to search a list of the meetings of the user operating the corresponding personal terminal 2 for a desired meeting by using a keyword (text). For example, the reference information of the meeting, text data and handwritten characters included in the personal memo dm, and the evaluation of the meeting by the user are searched through by using characters (text). Note that the reference information of the meeting is included in the meeting information.

Hardware Configuration:

Hardware Configuration of Computer:

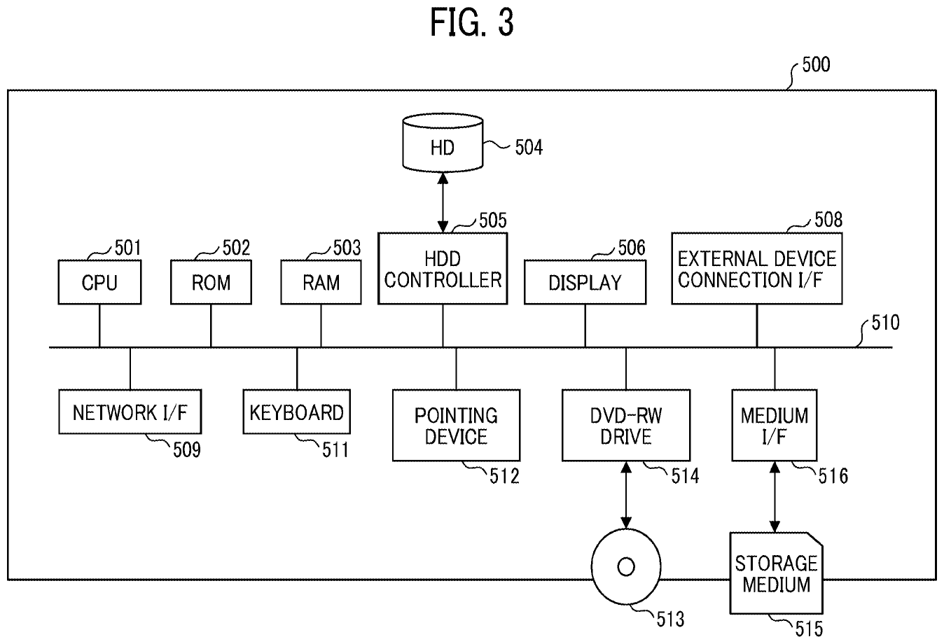

The content management server 6 is implemented by, for example, a computer 500 having a hardware configuration as illustrated in FIG. 3. Further, when the personal terminal 2 is a PC, which is an example of an information processing terminal, the PC is also implemented by the computer 500 having a hardware configuration as illustrated in FIG. 3, for example.

FIG. 3 is a block diagram illustrating an example of a hardware configuration of the computer 500, according to the present embodiment. As illustrated in FIG. 3, the computer 500 includes a central processing unit (CPU) 501, a read only memory (ROM) 502, a random access memory (RAM) 503, a hard disk (HD) 504, a hard disk drive (HDD) controller 505, and a display 506, an external device connection interface (I/F) 508, a network I/F 509, a data bus 510, a keyboard 511, a pointing device 512, a digital versatile disk rewritable (DVD-RW) drive 514, and a medium I/F 516.

The CPU 501 controls entire operation of the computer 500. The ROM 502 stores a program for controlling the CPU 501, such as an initial program loader (IPL). The RAM 503 is used as a work area for the CPU 501. The HD 504 stores various data such as a program. The HDD controller 505 controls reading and writing of various data from and to the HD 504 under control of the CPU 501.

The display 506 displays various information such as a cursor, menu, window, character, and image. The external device connection I/F 508 is an interface that connects the computer 500 to various external devices. Examples of the external devices include, but not limited to, a universal serial bus (USB) memory and a printer. The network I/F 509 is an interface that controls communication of data with an external device through the communication network 9. Examples of the data bus 510 include, but not limited to, an address bus and a data bus, which electrically connects the components such as the CPU 501 with one another.

The keyboard 511 is one example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

Hardware Configuration of Smartphone:

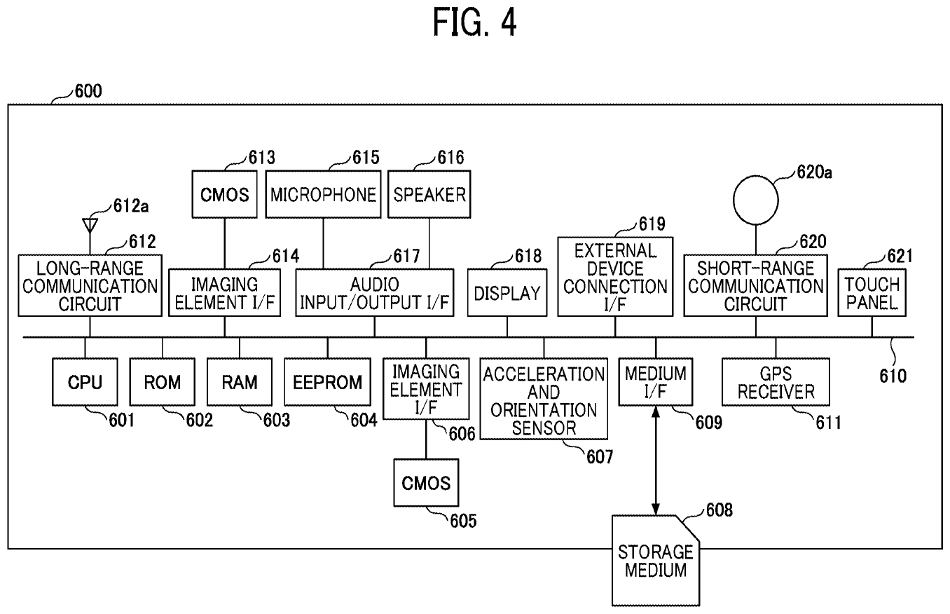

The personal terminal 2, which is an example of the information processing terminal, can be implemented by, for example, a smartphone 600 having a hardware configuration as illustrated in FIG. 4.

FIG. 4 is a block diagram illustrating an example of a hardware configuration of the smartphone 600, according to the present embodiment. As illustrated in FIG. 4, the smartphone 600 includes a CPU 601, a ROM 602, a RAM 603, an electrically erasable and programmable ROM (EEPROM) 604, a complementary metal oxide semiconductor (CMOS) sensor 605, an imaging element I/F 606, an acceleration and orientation sensor 607, a medium I/F 609, and a global positioning system (GPS) receiver 611.

The CPU 601 controls entire operation of the smartphone 600. The ROM 602 stores a control program for controlling the CPU 601, such as an IPL. The RAM 603 is used as a work area for the CPU 601. The EEPROM 604 reads or writes various data such as a control program for a smartphone under control of the CPU 601.

The CMOS sensor 605 is an example of a built-in imaging device configured to capture an object (mainly, a self-image of a user operating the smartphone 600) under control of the CPU 601 to obtain image data. In alternative to the CMOS sensor 605, an imaging element such as a charge-coupled device (CCD) sensor can be used. The imaging element I/F 606 is a circuit that controls driving of the CMOS sensor 605. Example of the acceleration and orientation sensor 607 includes an electromagnetic compass or gyrocompass for detecting geomagnetism and an acceleration sensor.

The medium I/F 609 controls reading and writing (storing) of data from and to a storage medium 608 such as a flash memory. The GPS receiver 611 receives a GPS signal from a GPS satellite.

The smartphone 600 further includes a long-range communication circuit 612, a CMOS sensor 613, an imaging element I/F 614, a microphone 615, a speaker 616, an audio input/output I/F 617, a display 618, an external device connection I/F 619, a short-range communication circuit 620, an antenna 620a for the short-range communication circuit 620, and a touch panel 621.

The long-range communication circuit 612 is a circuit that enables the smartphone 600 to communicate with other device through the communication network 9. The CMOS sensor 613 is an example of a built-in imaging device configured to capture an object under control of the CPU 601 to obtain image data. The imaging element I/F 614 is a circuit that controls driving of the CMOS sensor 613. The microphone 615 is a built-in circuit that converts sound into an electric signal. The speaker 616 is a built-in circuit that generates sound such as music or voice by converting an electric signal into physical vibration.

The audio input/output I/F 617 is a circuit for inputting or outputting an audio signal between the microphone 615 and the speaker 616 under control of the CPU 601. The display 618 is an example of a display device that displays an image of the object, various icons, etc. Examples of the display 618 include a liquid crystal display (LCD) and an organic electroluminescence (EL) display.

The external device connection I/F 619 is an interface that connects the smartphone 600 to various external devices. The short-range communication circuit 620 is a communication circuit that communicates in compliance with the near field communication (NFC), the Bluetooth (Registered Trademark), and the like. The touch panel 621 is an example of an input device configured to enable a user to operate the smartphone 600 by touching a screen of the display 618.

The smartphone 600 further includes a bus line 610. Examples of the bus line 610 include, but not limited to, an address bus and a data bus, which electrically connects the components illustrated in FIG. 4 such as the CPU 601.

Functional Configuration

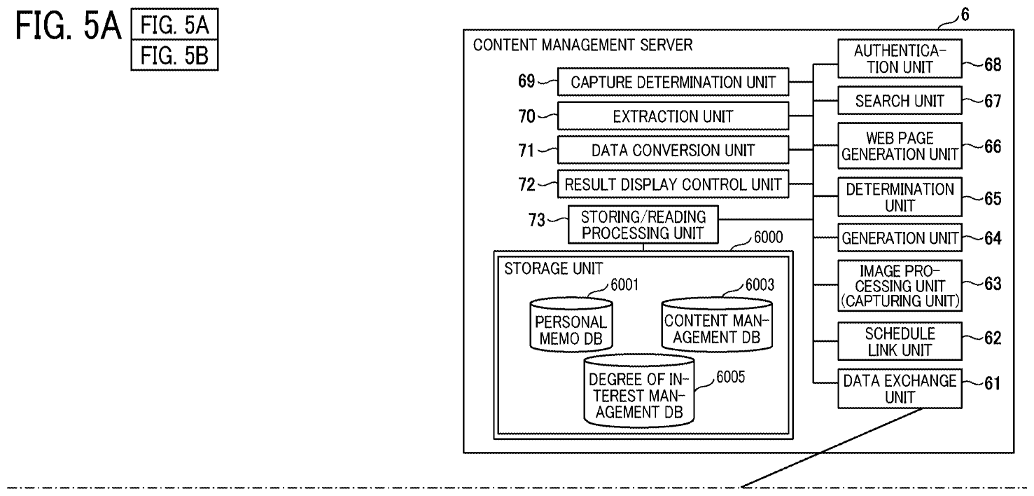

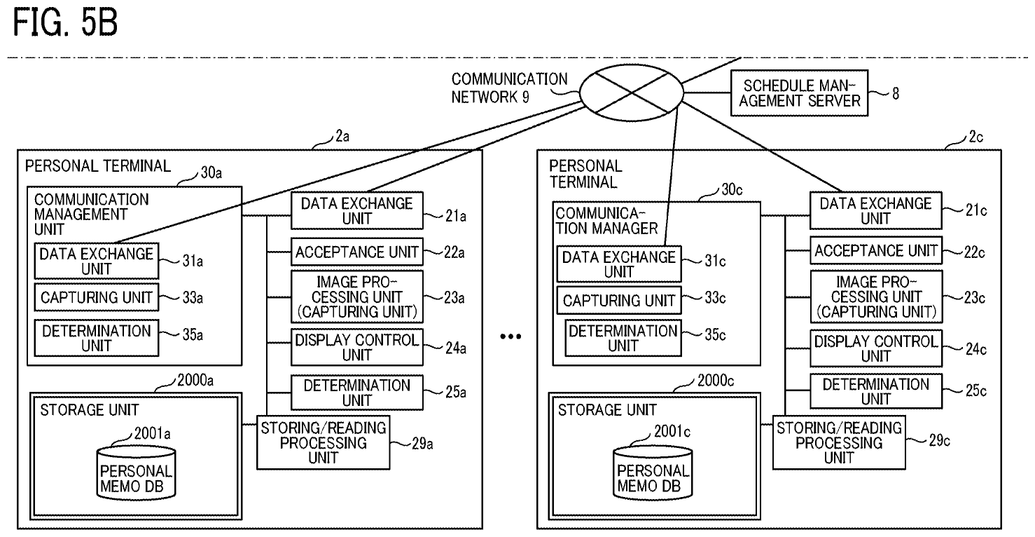

With reference to FIGS. 5A and 5B (FIG. 5), a description is given of an example of a functional configuration of each of the personal terminal 2 and the content management server 6 of the information sharing system. FIG. 5 is a block diagram illustrating an example of functional configurations of the personal terminal 2 and the content management server 6 of the information sharing system.

Functional Configuration of Personal Terminal:

First, a description is given of an example of a functional configuration of the personal terminal 2. As illustrated in FIG. 5, the personal terminal 2 includes a data exchange unit 21, an acceptance unit 22, an image processing unit 23, a display control unit 24, a determination unit 25, a storing/reading processing unit 29, and a communication management unit 30. These units are functions or means implemented by or caused to function by operating one or more hardware components illustrated in FIG. 3 in cooperation with instructions of the CPU 501 according to the program loaded from the HD 504 to the RAM 503. The personal terminal 2 further includes a storage unit 2000, which is implemented by the RAM 503 and the HD 504 illustrated in FIG. 3. The storage unit 2000 of the personal terminal 2 stores various databases, such as a personal memo DB 2001.

The data exchange unit 21, the acceptance unit 22, the image processing unit 23, the display control unit 24, the determination unit 25, and the storing/reading processing unit 29 are implemented by the web browser (the web application of the web browser) that displays a personal board dc described below. The communication management unit 30 is implemented by a dedicated communication application.

Next, a detailed description is given of each functional unit of the personal terminal 2. The data exchange unit 21 transmits and receives various data (or information) to and from other terminals, apparatuses, servers, etc. through the communication network 9. For example, the data exchange unit 21 receives, from the content management server 6, content data described in a hypertext markup language (HTML), Cascading Style Sheet (CSS), and JavaScript (registered trademark). In addition, the data exchange unit 21 transmits operation information input by the user to the content management server 6.

The acceptance unit 22 receives various selections or instructions input by the user using the keyboard 511 and the pointing device 512. The image processing unit 23 performs processing such as generating vector data (or stroke data) according to drawing by the user, for example. The image processing unit 23 has a function as a capturing unit. For example, the image processing unit 23 shoots a capture of the shared screen ss, to acquire a capture image.

The display control unit 24 controls the display 506 to display a personal board dc described below. The determination unit 25 performs various determinations. The storing/reading processing unit 29 is implemented by instructions from the CPU 501, and the HDD controller 505, the medium I/F 516, and the DVD-RW drive 514. The storing/reading processing unit 29 stores various data in the storage unit 2000, the DVD-RW 513, and the storage medium 515, and reads the various data from the storage unit 2000, the DVD-RW 513, and the storage medium 515.

The communication management unit 30, which is implemented mainly by instructions of the CPU 501 illustrated in FIG. 3, performs data input/output with the data exchange unit 21, for example. The communication management unit 30 further includes a data exchange unit 31, a capturing unit 33, and a determination unit 35.

The data exchange unit 31 transmits and receives various data (or information) to and from the content management server 6 through the communication network 9, independently of the data exchange unit 21. The capturing unit 33 basically has the same function as the image processing unit 23 as the capturing unit. For example, the capturing unit 33 performs screen capturing of the shared screen ss described below, to acquire capture image. The determination unit 35 performs various determinations.

Functional Configuration of Content Management Server:

A description is now given of an example of a functional configuration of the content management server 6. As illustrated in FIG. 5, the content management server 6 includes a data exchange unit 61, a schedule link unit 62, an image processing unit 63, a generation unit 64, a determination unit 65, a web page generation unit 66, a search unit 67, an authentication unit 68, a capture determination unit 69, an extraction unit 70, a data conversion unit 71, a result display control unit 72, and a storing/reading processing unit 73. These units are functions or means implemented by or caused to function by operating one or more hardware components illustrated in FIG. 3 in cooperation with instructions of the CPU 501 according to the program loaded from the HD 504 to the RAM 503. The content management server 6 further includes a storage unit 6000, which is implemented by the RAM 503 and the HD 504 illustrated in FIG. 3.

Next, a detailed description is given of each functional unit of the content management server 6. The data exchange unit 61 transmits and receives various data (or information) to and from other terminals, apparatuses, servers, etc. through the communication network 9. The schedule link unit 62 acquires schedule information including reference information of the meeting in which the user participates from a schedule management server 8. The schedule management server 8 is connected to the communication network 9 so that various data (or information) can be transmitted and received. The schedule management server 8 stores schedule information (meeting (list) information) for each user (each user ID).

The image processing unit 63 has a function as a capturing unit, and performs screen capturing of the shared screen ss described below, to acquire a capture image. The generation unit 64 generates a personal board ID, page ID, etc. The determination unit 65 performs various determinations.

The web page generation unit 66 generates data of a web page to be displayed on the web browser of the personal terminal 2. The search unit 67 accepts a search request from a personal portal screen, which is described below, displayed on the web browser of the personal terminal 2 and performs a search according to the accepted search request. The authentication unit 68 performs user authentication processing. The authentication unit 68 can be provided in any suitable sources other than the content management server 6. For example, an authentication server connected to the communication network 9 can be used.

The capture determination unit 69 determines the occurrence of a trigger for shooting the capture of the shared screen ss to capture the capture image. The trigger for capturing the capture image differs depending on whether the user requests capture of image by himself or herself, or when the same capture image is distributed to all users.

The extraction unit 70 extracts, for each capture image (for each page), the writing content that the user freely writes as a memo on the capture image or in a margin of the capture image. The data conversion unit 71 quantifies the writing content extracted by the extraction unit 70 into numerical data such as a number of lines or a data size. The data size is used to indicate an amount of data. The result display control unit 72 analyzes the numerical data of the writing content, obtained by the data conversion unit 71, for example, by comparing the numerical data between users or capture images. Based on the analysis result, the result display control unit 72 displays a result display screen, which indicates information for estimating the degree of user's interest with respect to the capture image, or indicates the degree of interest estimated from the analysis result.

The storing/reading processing unit 73 is implemented by instructions from the CPU 501, and the HDD controller 505, the medium I/F 516, and the DVD-RW drive 514. The storing/reading processing unit 73 stores various data in the storage unit 6000, the DVD-RW 513, and the storage medium 515, and reads the various data from the storage unit 6000, the DVD-RW 513, and the storage medium 515.

The storage unit 6000 of the content management server 6 includes a personal memo database (DB) 6001, a content management DB 6003, and a degree of interest management DB 6005. The personal memo DB 6001, the content management DB 6003, and the degree of interest management DB 6005 will be described later in detail.

Note that these data may be stored in any suitable server other than the content management server 6. In this case, the data may be acquired and transmitted from other server each time the personal terminal 2 sends a request for data acquisition and transmission. In another example, the data is stored in the content management server 6 during the meeting or while the personal board dc is referenced by the user, and the data can be deleted from the content management server 6 and sent to other server after the end of the meeting or the reference (or after a certain period of time).

The apparatuses or devices described in the embodiment are merely one example of plural computing environments that implement one or more embodiments disclosed herein. In some embodiments, the content management server 6 includes multiple computing devices, such as a server cluster. The multiple computing devices are configured to communicate with one another through any type of communication link, including a network, a shared memory, etc., and perform processes disclosed herein. In substantially the same manner, the personal terminal 2 can include multiple computing devices configured to communicate with one another.

Further, the content management server 6 and the personal terminal 2 can be configured to share the disclosed processes in various combinations. For example, a part of processes to be executed by the content management server 6 can be executed by the personal terminal 2. Further, the elements of the content management server 6 and the personal terminal 2 may be combined into one apparatus or may be divided into a plurality of apparatuses.

DB Structure:

Content Management DB:

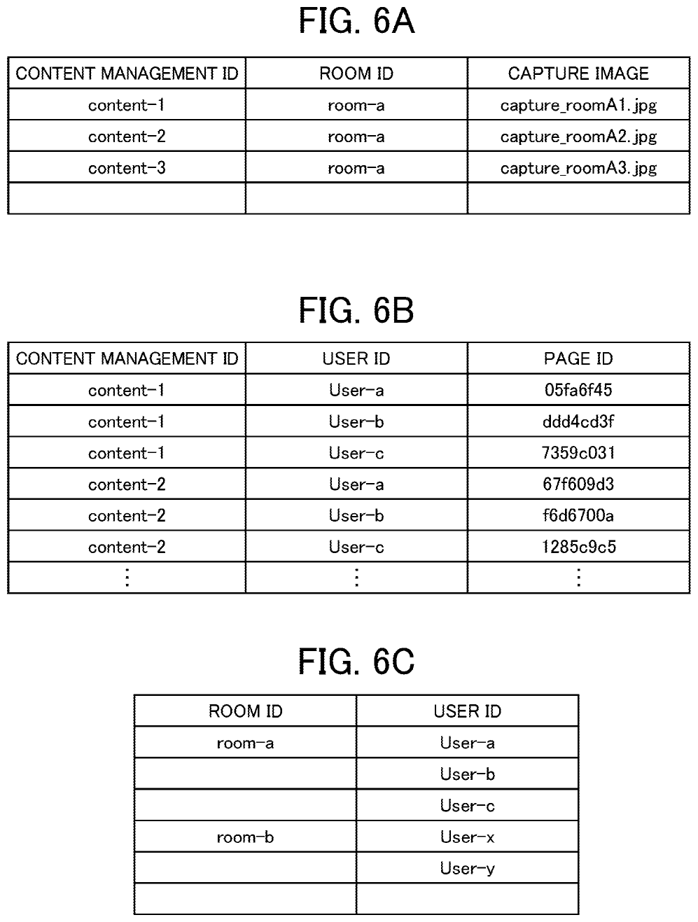

FIG. 6A, FIG. 6B and FIG. 6C (FIG. 6) are tables each illustrating an example of a data structure of the content management DB 6003. The storage unit 6000 of the content management server 6 includes the content management DB 6003 as illustrated in FIG. 6. In this disclosure, the content management DB 6003 in FIG. 6 illustrates an example case in which the same captured image is distributed to all users who have participated in the conference.

The content management DB 6003 is configured by a combination of data structures of FIGS. 6A to 6C.

The table of FIG. 6A has a data structure, which associates a room ID and a file name of a capture image, for each content management ID. The content management ID is an example of identification information identifying a capture image. The room ID is an example of identification information identifying the room. The file name of the capture image is an example of identification information identifying an electronic file of the capture image. With the table of FIG. 6A, the capture image is associated with the room.

The table of FIG. 6B has a data structure, which associates a user ID and a page ID, for each content management ID. The user ID is an example of identification information identifying a user. The page ID is an example of identification information identifying the capture image distributed to the user. Different page IDs are assigned to capture images distributed to different users, even if the same capture image is assigned with the same content management ID. The table of FIG. 6C has a data structure, which associates a room ID and a user ID. With the table of FIGS. 6B and 6C, the capture image distributed to each user is associated with each of all users who participated in the conference.

For example, in the example case illustrated in FIG. 6A, the room ID and the file name of the capture image are registered in association with the content management ID (an example of identification information of the capture image) when a capture shooting process described below is executed. Referring to the table of FIG. 6C, the user IDs of all users participating in the conference being held in that room are registered. Referring to the table of FIG. 6B, capture images having the same content management ID, which are distributed to all users participating in the conference, are registered with different page IDs.

Using the content management DB 6003 of FIG. 6, the content management server 6 can manage capture images registered in the room, and can manage, for each user participating in the room, the capture image distributed to each user using the page ID unique to each user.

Personal Memo DB:

The personal memo DB 6001 stores data such as a personal board ID, a page ID, memo data, and a display position in association with one another. The personal board ID is an example of identification information identifying a personal board dc. The page ID is an example of identification information identifying the capture image that is distributed to each user. The memo data is an example data of writing content that the user freely writes as a memo on the capture image or in a margin of the capture image. The display position indicates a position (coordinates, the number of lines, the number of characters, etc.) at which the writing content is displayed.

Degree of Interest DB:

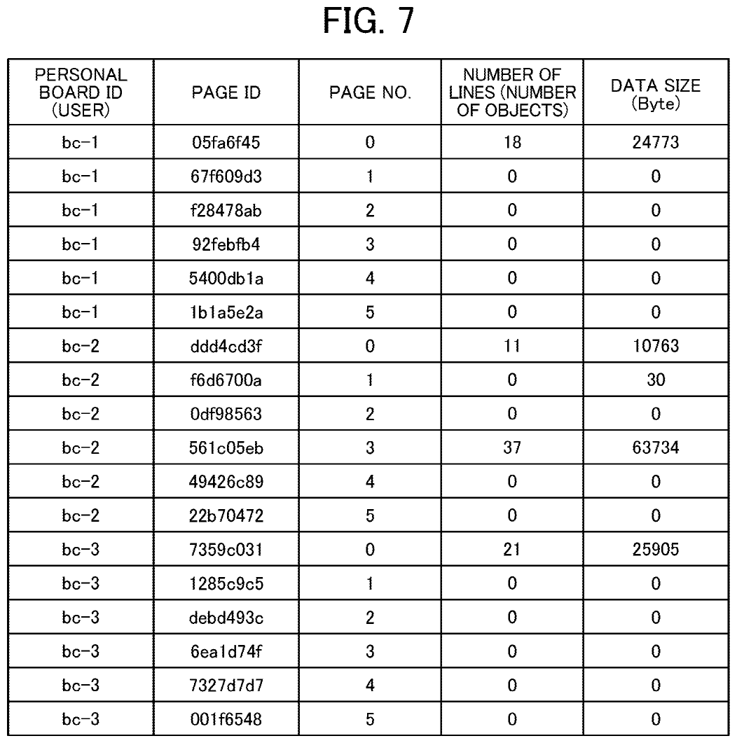

FIG. 7 is a table illustrating an example of a data structure of the degree of interest DB 6005. The storage unit 6000 of the content management server 6 stores the degree of interest DB 6005 as illustrated in FIG. 7. In this disclosure, the degree of interest DB 6005 in FIG. 7 illustrates an example case in which the same captured image is distributed to all users who participate in the conference.

The degree of interest DB 6005 stores the personal board ID, the page ID, the page number, the number of lines, and the data size in association with one another. The personal board ID is uniquely associated with the user ID. The page number is a page number of the capture image identified with a particular page ID.

FIG. 7 illustrates an example in which the capture images with the page numbers “0” to “5” are distributed to each of three users. The number of lines and the data size in FIG. 7 are an example of numerical data, obtained by quantifying the writing content that the user freely writes as a memo on the capture image or in a margin of the capture image.

In the present embodiment, if the capture image is of high interest to a particular user, it is assumed that writing of memos will increase for that particular user. Accordingly, the writing content is quantified into numerical data such as a number of lines or data size. Based on comparison using numerical data, the degree of user's interest on the capture image can be determined for each user or for each capture image.

Processes or Operation:

A description is given now of an operation or processes according to the present embodiment. In the present embodiment, an example is described in which in a meeting conducted by the room, the user A, who operates the personal terminal 2a, uploads (streams) content data to the shared screen ss, and the user B and the user C, who respectively operate the personal terminal 2b and the personal terminal 2c participate in the meeting. The user A is an example of a presenter. Each of the user B and the user C is an example of an attendee.

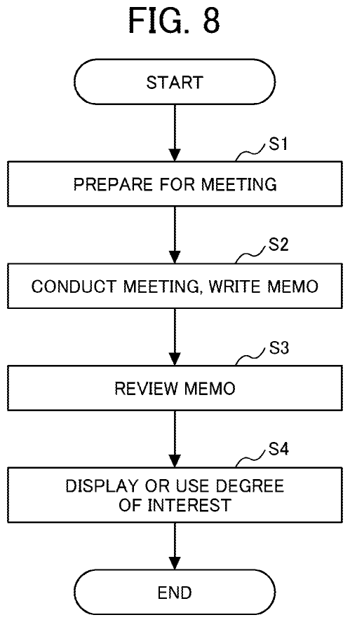

FIG. 8 is a flowchart illustrating an example of an operation performed by the information sharing system, according to the present embodiment. At S1, the information sharing system assists users in preparation for a meeting. In the meeting preparation, preparation of a room is performed in response to a request from the personal terminal 2a operated by the presenter, and connection to the room from the personal terminal 2a, the personal terminal 2b, and the personal terminal 2c is performed. The personal boards dc1, dc2, and dc3 are displayed on the personal terminals 2a, 2b, and 2c connected to the room, respectively.

At S2, a meeting is conducted using the information sharing system. In response to a request from the personal terminal 2a operated by the presenter, the information sharing system transmits data, by streaming, to the shared screen ss of the room, to display the shared screen ss on each of the personal terminals 2a to 2c. The information sharing system captures an image of the shared screen ss as the capture image, and distributes the capture image to each of the personal terminals 2a to 2c.

Each of the personal terminals 2a to 2c displays the capture image of the shared screen ss, which has been distributed, on the personal board dc. The user can freely write (or fill in) a memo on, or in a margin of, the capture image displayed on the personal board dc. Various DBs, which are described above, are updated with the writing contents (contents of a written memo).

At S3, the information sharing system controls each personal terminal 2 to display the corresponding personal board dc, to allow each user to view the writing content that the user has written during the meeting, such that each user can review the memo written during the meeting. The user may write anything on the personal board dc such as by inputting a handwritten memo on the captured image or its margin, drawing an object, or inputting text data, at any time as the user can do during the meeting.

For example, at the personal terminal 2, in response to detection of the acceptance unit 22a on input of information by the user, the storing/reading processing unit 29 may store information on the writing content on the personal memo DB 2001. The communication management unit 30 may transmit information on the writing content at any time, to the content management server 6. At the content management server 6, the storing/reading processing unit 73 stores information on the writing content, received from each of the personal terminals 2, on databases such as the personal memo DB 6001 and the content management DB 6003.

At S4, the information sharing system quantifies the writing content written on, or in a margin of, the capture image, into numerical data. Using this numerical data, the information sharing system performs quantitative evaluation, and determines the degree of user's interest on the captured image, which can be displayed or utilized as described below. Information on the degree of interest of each participant on the capture image, or information useful for estimating the degree of interest of each participant, may be referred to by the presenter or organizer of the meeting, to be used for approaching each participant (sales, etc.), or as feedback to improve the next meeting.

S3 and S4 may be performed at any time during or after the meeting. For example, the extraction unit 70 refers to the personal memo DB 6001 to obtain the memo data, which corresponds to writing content that the user freely writes as a memo on the capture image or in a margin of the capture image. The data conversion unit 71 quantifies the writing content into numerical data based on, for example, a number of lines or marks, or a number of characters, as described below. The storing/reading processing unit 73 stores the numerical data in the degree of interest management DB 6005. For example, as described above referring to FIG. 7, the storing/reading processing unit 73 stores, for a particular personal board ID and a particular page ID, the number of lines and the data size, as numerical data obtained by quantifying the writing content. Based on the numerical data, the result display control unit 72 displays, for example, information on the degree of interest of each user for each capture image as described below.

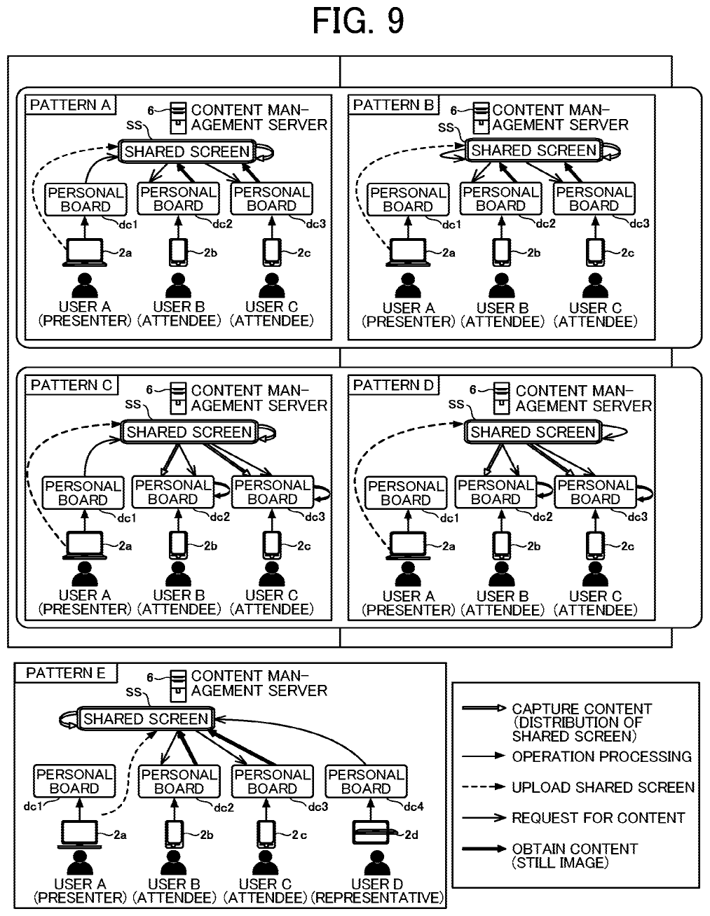

The distribution of the capture image at S2 is performed in any of various patterns as illustrated in FIG. 9, for example. FIG. 9 is an illustration of example patterns of content distribution and content acquisition. In FIG. 9, there are five patterns depending on the difference in triggers for starting capture shooting process, which is described below, and the difference in the terminals or server which performs the capture shooting process. Specifically, FIG. 9 illustrates content distribution by the presenter, automatic distribution by the content management server 6, and content distribution by a representative, as the difference in the triggers for starting the capture shooting process. The representative is a user D, who is neither a presenter nor an attendee. Further, FIG. 9 illustrates content acquisition by the content management server 6 and content acquisition by the personal board dc (personal terminal 2), as the difference in the terminals or server which performs the capture shooting process.

The content distribution by the presenter is an example in which the capture shooting process is performed according to the presenter's operation. The content distribution by the representative is an example in which the capture shooting process is performed according to the representative's operation. The automatic distribution by the content management server 6 is an example in which the capture shooting process is performed according to detection of change in image performed by the content management server 6. For example, when the image being displayed is changed, the content management server 6 detects that the image changes to perform the capture shooting process. The content acquisition by the content management server 6 is an example in which a capture shooting process is performed by the content management server 6. The content acquisition by the personal board dc (personal terminal 2) is an example in which the capture shooting process is performed by the personal terminal 2.

Pattern A is an example in which the content distribution by the presenter and the content acquisition by the content management server 6 are executed. In the pattern A, the content management server 6 performs the capture shooting process according to the presenter's operation, and the personal terminal 2b and the personal terminal 2c acquire the capture image from the content management server 6.

Pattern B is an example in which the automatic distribution by the content management server 6 and content acquisition by the content management server 6 are executed. In the pattern B, the capture shooting process is performed by the content management server 6 in response to the image change detection performed by the content management server 6, and the personal terminal 2b and the personal terminal 2c acquire the capture image from the content management server 6.

Pattern C is an example in which the content distribution by the presenter and the content acquisition by the personal board dc (personal terminal 2) are executed. The pattern C is an example in which the personal terminal 2 performs the capture shooting process according to the operation by the presenter.

Pattern D is an example in which the automatic distribution by the content management server 6 and the content acquisition by the personal board dc (personal terminal 2) are executed. In the pattern D, the capture shooting process is performed by the personal terminal 2 in response to the image change detection performed by the content management server 6.

Pattern E is an example in which the content distribution by the representative and the content acquisition by the content management server 6 are executed. In the pattern E, the content management server 6 performs the capture shooting process according to the representative's operation, and the personal terminal 2b and the personal terminal 2c acquire the capture image from the content management server 6. In still another example, in the pattern E, the capture shooting processing may be performed by the personal terminal 2b and the personal terminal 2c, or the capture shooting processing may be performed by the personal terminal 2d and the capture image may be transmitted to the personal terminals 2b and 2c via the content management server 6.

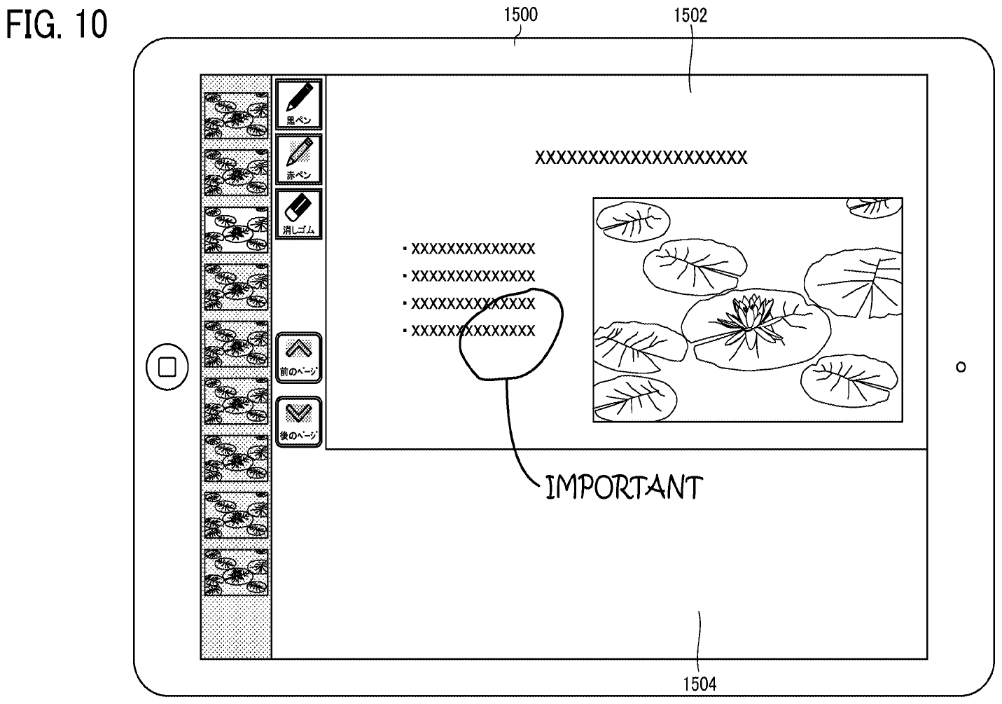

In the patterns A and B, displaying the shared screen ss on the personal terminal 2b and the personal terminal 2c of the attendees is optional. In the patterns A and B, in a case where the shared screen ss is not displayed on the personal terminal 2b and the personal terminal 2c of the attendee B and the attendee C, the shared screen does not have to be transmitted from the content management server 6 to the personal terminal 2b and the personal terminal 2c. In a user interface (UI) displayed on the personal terminal 2a and the personal terminal 2c, at least a capture image is displayed as an UI illustrated in FIG. 10.

In still another example, in the patterns C and D, instead of causing the personal terminal 2b and the personal terminal 2c to perform the capture shooting processing, the capture shooting processing may be performed by the personal terminal 2a and the capture image may be transmitted to the personal terminal 2b and the personal terminal 2c via the content management server 6.

FIG. 10 is an illustration of an example of the UI of the information sharing system, according to the present embodiment. The UI 1500 illustrated in FIG. 10 has a page selection area, an operation selection area, a content display area 1502, and a margin area 1504.

The page selection area provided on the leftmost of the UI 1500 is an area in which thumbnails of capture images are displayed as pages. In the operation selection area, which is provided between the page selection area and the content display area 1502, buttons that accepts an operation to select a black pen, a red pen, and an eraser used for a handwritten memo, and buttons that accept operations to move to a previous page or a next page are displayed.

In the content display area 1502, a capture image is displayed. In the margin area 1504, various memos can be recorded. The handwritten memo such as handwriting text or object arrangement can be written in both the content display area 1502 and the margin area 1504.

In the following, patterns A and C of FIG. 9 will be described as an example of the process of distributing and acquiring the captured image at S2 of FIG. 8.

Pattern A:

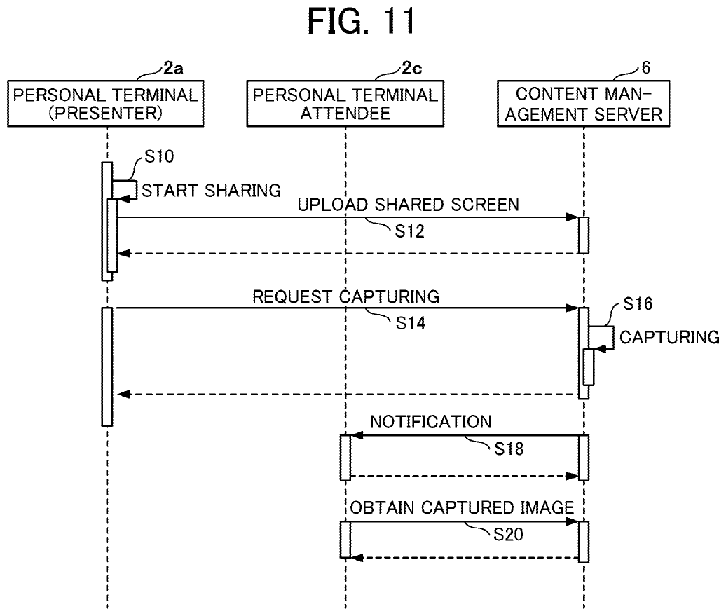

In the pattern A, for example, a capture image is generated by the procedure illustrated in FIG. 11, and the generated capture image is displayed on the UI of the personal terminal 2c. FIG. 11 is a sequence diagram illustrating an example of an operation performed by the information sharing system, according to the present embodiment. The personal terminal 2b is omitted in FIG. 11, in order to simplify the drawings.

At S10, the information sharing system prepares for a meeting. In the meeting preparation, preparation of a room is performed in response to a request from the personal terminal 2a operated by the presenter, and connection to the room from the personal terminal 2b and the personal terminal 2c is performed. The user A, the user B, and the user C of the personal terminal 2a, the personal terminal 2b, and the personal terminal 2c, who are connected to the room are registered in the table of FIG. 6C, and conduct the meeting. The personal terminal 2a accepts an operation of selecting a target to be streamed to the shared screen ss. This operation is an example of an operation of starting sharing from the presenter.

For example, the operation of selecting the target to be streamed to the shared screen ss is to select an entire screen of the personal terminal 2a. In another example, the operation of selecting the target to be streamed to the shared screen ss is to select a window of a particular application, or to select a tab of the web browser.

At S12, the personal terminal 2a uploads data of the content selected to be streamed to the shared screen ss of the content management server 6 by streaming. After the process of S12, the personal terminal 2a continues to stream the data of the content selected as the streaming transmission target to the shared screen ss of the content management server 6.

The presenter can instruct the personal terminal 2a to send a capture shooting request to capture the shared screen ss. While viewing the shared screen ss being displayed, the presenter performs an operation that instructs a capture shooting request at the timing at which the presenter wants to take a capture image. In response to receiving the operation of instructing a capture shooting request, the presenter's personal terminal 2a transmits a capture shooting request to the content management server 6 at S14.

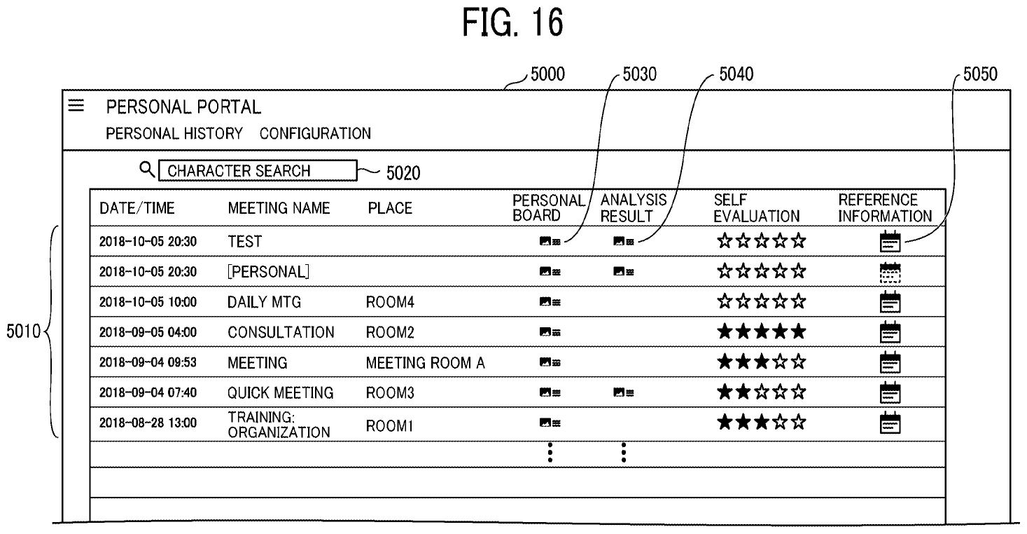

In response to receiving the capture shooting request, at S16, the content management server 6 shoots a capture image of the shared screen SS of the current time. The content management server 6 searches the table of FIG. 6C to identify a particular room ID associated with the user ID of the presenter operating the personal terminal 2a from which the capture shooting request is received at S14. Further, the content management server 6 searches the table of FIG. 6C to identify the user IDs associated with the identified particular room ID, other than the user ID of the presenter, as the user IDs of the attendees. The content management server 6 registers information on the capture image captured at S16 in the tables of FIGS. 16A and 16B in association with the identified room ID, the user ID of the presenter, and the user IDs of the attendees.

The operation proceeds to S18, and the content management server 6 transmits a notification indicating that the capture image is shot to the personal terminal 2b of the attendee B and the personal terminal 2c of the attendee C associated with the same room ID of the presenter. The operation proceeds to S20, and each of the personal terminal 2b and the personal terminal 2c transmits, to the content management server 6, a request for acquiring the capture image of the shared screen ss based on the notification received at S18. The content management server 6 causes the personal terminal 2b of the attendee B and the personal terminal 2c of the attendee C to acquire the capture image of the shared screen ss according to the content management DB 6003 of FIG. 6.

As described heretofore, in the pattern A, the capture image of the shared screen ss is captured in response to the capture shooting request from the presenter, and the personal terminal 2 of the attendee acquires the capture image. Thus, the presenter can allow the attendee(s) to sequentially acquire the capture images as the meeting progresses. Further, the presenter can select his/her desired capture image(s) to be acquired by the attendee.

Pattern C:

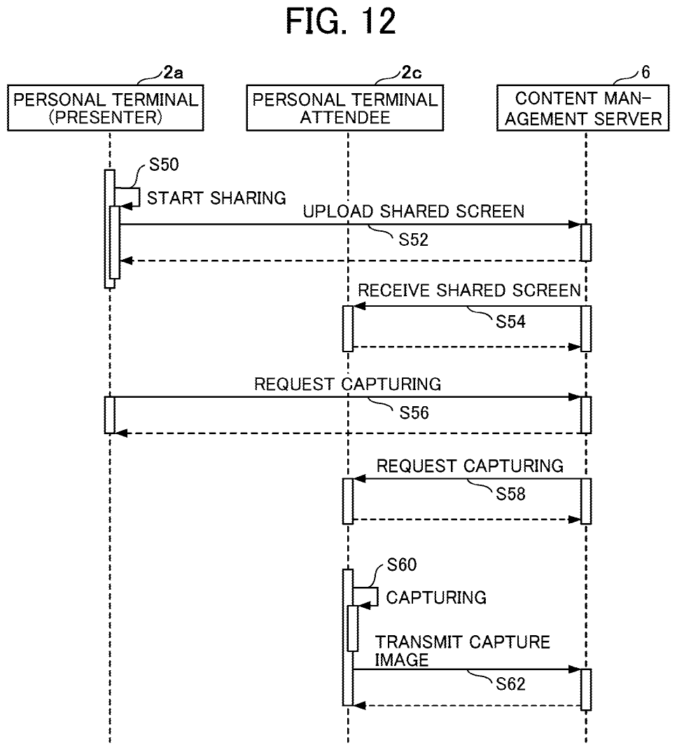

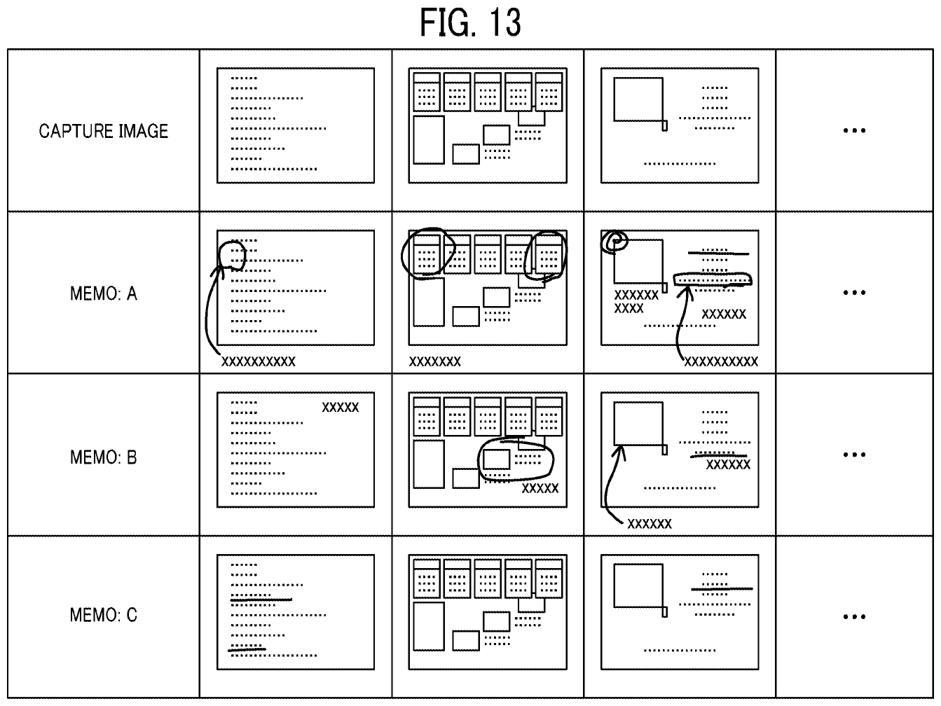

In the pattern C, for example, a capture image is generated by the procedure illustrated in FIG. 12, and the generated capture image is displayed on the UI of the personal terminal 2c. FIG. 12 is a sequence diagram illustrating an example of an operation performed by the information sharing system, according to the present embodiment. The personal terminal 2b is omitted in FIG. 12, in order to simplify the drawings.

At S50, the information sharing system accepts a sharing start operation from the presenter in the same or substantially the same manner as S10 of FIG. 11. At S52, the personal terminal 2a uploads data of the content selected to be streamed to the shared screen ss of the content management server 6 by streaming. After the process of S52, the personal terminal 2a continues to stream the data of the content selected as the streaming transmission target to the shared screen ss of the content management server 6.

The operation proceeds to S54, and the content management server 6 transmits the content data uploaded by streaming to the shared screen ss, to the personal terminal 2b and the personal terminal 2c of the attendees who are identified as participating in the same room in which the presenter is participating based on the table of FIG. 6C. Thus, the personal terminal 2b and the personal terminal 2c of the attendees participating in the room receive the image of the shared screen ss.

The presenter can instruct the personal terminal 2a to send a capture shooting request to capture the shared screen ss. While viewing the shared screen ss being displayed, the presenter performs an operation that instructs a capture shooting request at the timing at which the presenter wants to take a capture image. In response to receiving the operation to instruct the capture shooting request, the presenter's personal terminal 2a transmits a capture shooting request to the content management server 6 at S56.

At S58, the content management server 6 transmits the capture shooting request received from the personal terminal 2a of the presenter, to the personal terminal 2b and the personal terminal 2c of the attendees who are identified as participating in the same room in which the presenter is participating based on the table of FIG. 6C.

In response to receiving the capture shooting request, at S60, each of the personal terminal 2b and the personal terminal 2c shoots a capture image of the shared screen ss of the current time. The operation proceeds to S62, and each of the personal terminal 2b and the personal terminal 2c displays the capture image taken at S60, as the UI 1500 illustrated in FIG. 10, for example. Further, each of the personal terminal 2b and the personal terminal 2c transmits the capture image taken at S62 to the content management server 6.

Further, the content management server 6 registers information of the received capture image in the tables of FIG. 6A and FIG. 6B. Since the content management server 6 registers information of the received capture image in the tables of FIG. 6A and FIG. 6B, the content management server 6 is able to reload the UI 1500 or transmit the capture image to the personal terminal 2 of an attendee who participates in the meeting after the meeting has started.

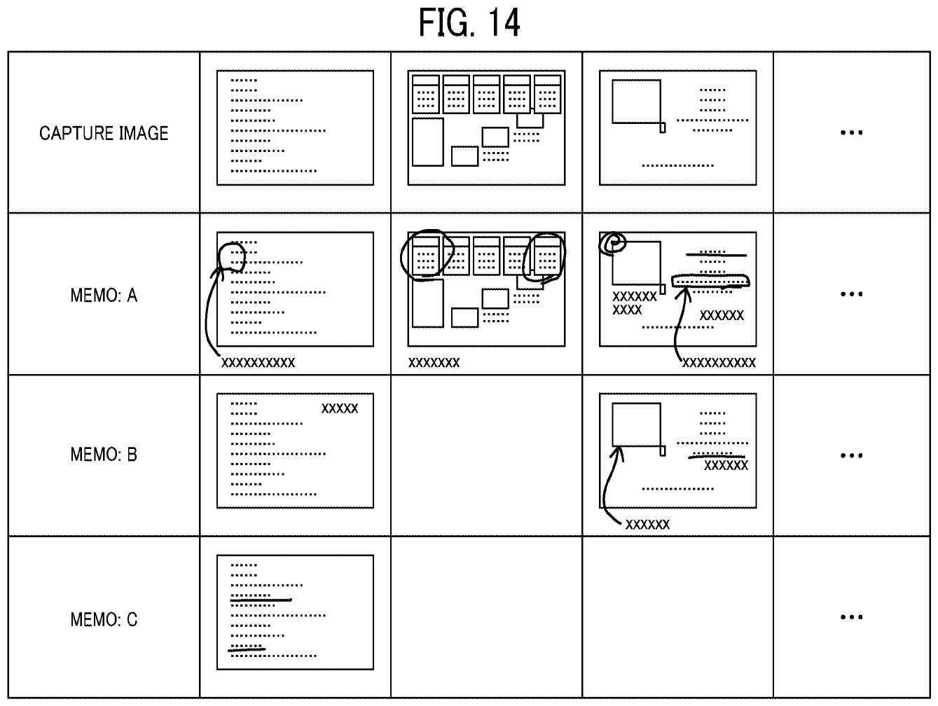

As described above referring to S2 of writing the memo, the user can freely write (fill in) the memo on the capture image displayed on the personal board dc or in the blank space (such as a margin) as illustrated in FIG. 13 or FIG. 14, for example.

FIG. 13 is a diagram illustrating an example of a capture image and a memo written on the capture image or a margin of the capture image. FIG. 13 illustrates an example in which the same capture image is transmitted to any personal terminal 2 connected to the same room, such that each user in the room is distributed with the same capture image. Each user can freely write a memo on, or in a margin of, the capture image that is distributed.

When a user, as an attendee, makes a capture shooing request of a capture image by himself/herself, a number of capture images to be taken may differ between users as illustrated in FIG. 14. FIG. 14 is a diagram illustrating an example of a capture image and a memo written on the capture image or a margin of the capture image in such case. Each user can make a capture shooting request to acquire the capture image, and freely write a memo on the capture image or in a margin of the capture image.

FIGS. 13 and 14 each illustrate each page of capture images having been taken by each attendee.

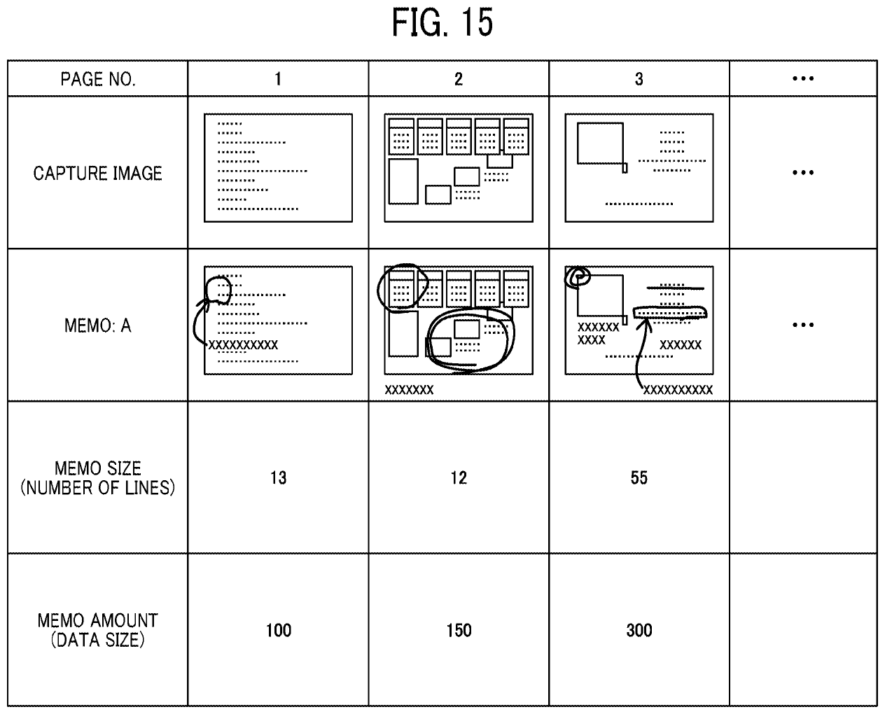

As illustrated in FIG. 13 or FIG. 14, the extraction unit 70 of the content management server 6 extracts the writing content freely written by the user as a memo on, or in a margin of, the capture image, for each user on a page-by-page basis of the capture image. The data conversion unit 71 of the content management server 6 quantifies the writing content, extracted by the extraction unit 70, for each user on a page-by-page basis of the capture image, into numerical data such as a number of lines or a data size of the writing content, for example, as illustrated in FIG. 15.

FIG. 15 is a diagram illustrating an example of an amount of memo, which is an example of numerical data that quantifies the writing content that is extracted. In FIG. 15, the content of memo written by the user A for the capture image is quantified into a form (numerical value), which allows quantitative evaluation, such as an amount of memo that can be represented by a number of lines or data size.

Specifically, in FIG. 15, for each page of the capture image, the capture image, memo written by the user A, information on an amount of memo (number of lines, data size) are displayed in association.

For example, at conferences or seminars, if the user is interested in the content of the capture image being distributed, the user is most likely to draw a line, mark, or write characters, etc., on the capture image or in its margin, such that writing of memo (memo amount) increases. In the present embodiment, the amount of memo written by the user on the captured image or in its margin is quantified into numerical data that can reflect an amount of memo. It is determined that the degree of user's interest is high for the capture image having a large amount of memo, and the degree of user's interest is low for the capture image having a small amount of memo.

In one example, the data conversion unit 71 quantifies the content of memo based on a number of characters of text data, written by the user on the capture image or in its margin, by operating the keyboard 511, for example. In another example, the data conversion unit 71 quantifies the content of memo based on a number of handwritten characters input by the user, by performing character recognition.

In another example, the data conversion unit 71 quantifies the content of memo written by the user based on a number of lines (a number of objects) extracted from the content of memo. For example, the alphabet “A” is quantified into three lines. The number “5” is quantified into two lines.

Accordingly, in the present embodiment, the amount of memo increases, when the number of lines or marks on the capture image or in its margin is large, when the number of written characters is large, or when a written character has a large number of strokes. Since the user often has a limited time to take memo during the meeting, the user is not likely to write characters with a large number of strokes. For this reasons, information on a number of strokes may be omitted. Even so, as long as the lines or marks, or a number of characters that are written on, or in a margin of, the capture image, can be extracted, it is expected that the degree of user's interest can be measured.

In another example, the data conversion unit 71 quantifies the content of memo based on a data amount (drawn area) of memo written by the user on the capture image or in its margin. In another example, the data conversion unit 71 quantifies the content of memo written by the user based on an area of lines drawn by the user on the capture image or in its margin. For example, the amount of memo increases when the lines drawn by the user on the capture image or in its margin are long or thick.

Accordingly, in the present embodiment, the amount of memo increases, when the number of lines or marks on the capture image or in its margin is large, when the number of written characters is large, when a long line or a thick line is drawn, or when a character with a large size is written.

It is determined that a space that can be used by the user to write memo is limited, and such space does not differ between the capture images or users, as a size in written character does not greatly differ between users. For this reasons, information on a size of character may be omitted. Even so, as long as the lines or marks, or a number of characters that are written on, or in a margin of, the capture image, can be extracted, it is expected that the degree of user's interest can be measured. Further, when long or thick lines, or large-size characters are extracted, it is expected that the degree of user's interest can be measured.

The amount of memo written by the user for the capture image, which has been quantified as described above, is used at S4 of determining, displaying, or utilizing the degree of interest of each user for a particular capture image. At S4, the degree of user's interest on the capture image is determined, according to the amount of memo by the user for the capture image, which has been quantified for each page of the capture image.

At S4, the content management server 6 may determine the degree of user's interest on the capture image, and display the result of determination on a result display screen described later. Alternatively, the content management server 6 may display information used for determining the degree of user's interest on the result display screen.

Further, the memo amount on the capture image may be quantified at any other timing than S4 of when the degree of user's interest is displayed. For example, the memo amount may be quantified at the end of meeting, or may be quantified every time the content management server 6 receives writing of user to keep updating the numerical data.

For example, the result display control unit 72 of the content management server 6 refers to the memo amount of a particular user on the capture image, which is quantified for each page. Referring to the memo amount, the result display control unit 72 may display the capture image with the largest memo amount, on the result display screen, as the capture image with the highest degree of interest for that user. Alternatively, using the memo amount, the result display control unit 72 may display any number of capture images with a memo amount greater than or equal to a threshold, on the result display screen, as the captured image with high degree of interest for that user. In displaying, the result display control unit 72 may arrange the capture images (thumbnail images of capture images), such that the images with larger memo amount are displayed in priority, for example, at top of the screen.

For example, in the example of FIG. 15, the amount of memo written by the user A on the page 3 of the capture image is the greatest. Accordingly, it is determined that the page 3 of the capture image is of highest interest of the user A.

In another example, the result display control unit 72 of the content management server 6 refers to the memo amount of each of a plurality of users on the capture image, which is quantified for each page. Referring to the memo amount, the result display control unit 72 may display information on a particular user with the greatest amount of memo on a particular capture image, on the result display screen, as the user who is mostly interested in that capture image. Alternatively, the result display control unit 72 may display information on any user with the amount of memo that is equal to or greater than a threshold on the particular capture image, on the result display screen, as the user having high degree of interest in that capture image. In displaying, the result display screen 72 may arrange the users (such as, user identifiers), such that the users with larger memo amount are displayed in priority, for example, at top of the screen.

For example, the presenter or the organizer of the meeting displays or utilizes information on the degree of interest of each participant on the capture image, as described below. The presenter or the organizer of the meeting (hereinafter simply referred to as the organizer) operates the personal terminal 2 to access the personal portal screen 5000 as illustrated in FIG. 16. FIG. 16 is a diagram illustrating a display example of a personal portal screen 5000.

The personal portal screen 5000 of FIG. 16 includes a list 5010 of meetings in which the organizer who operates the personal terminal 2 has organized or participated. The meeting list 5010 illustrated in FIG. 16 displays, as items for each meeting, a date and time, a meeting name, a place, a personal board button 5030, an analysis result button 5040, a self-evaluation, and reference information button 5050. The organizer views the personal portal screen 5000 as illustrated in FIG. 16 to check the meeting list 5010 listing meetings in which the organizer has organized or participated. The self-evaluation is an example of evaluation information.

The personal board button 5030 is linked to a personal board screen that displays the personal board dc of the corresponding meeting. The analysis result button 5040 is linked to the result display screen of the corresponding meeting. The analysis result button 5040 is displayed so as to correspond to the meeting in which the user was the organizer (that is, the organizer or presenter). The reference information button 5050 is linked to a reference information display screen that displays reference information of the corresponding meeting.

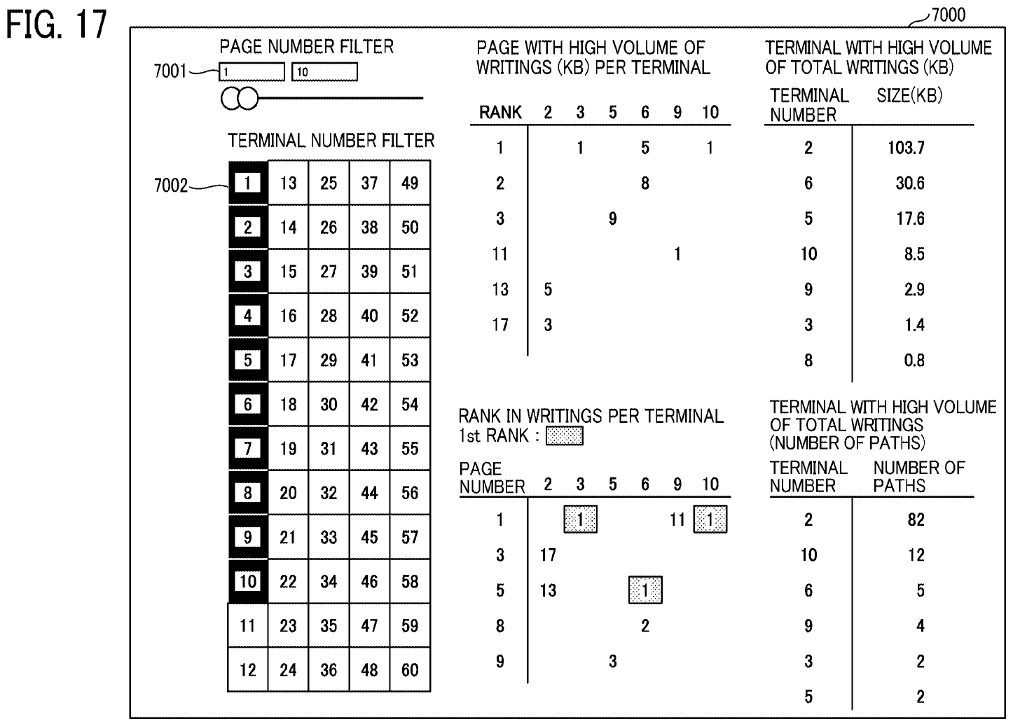

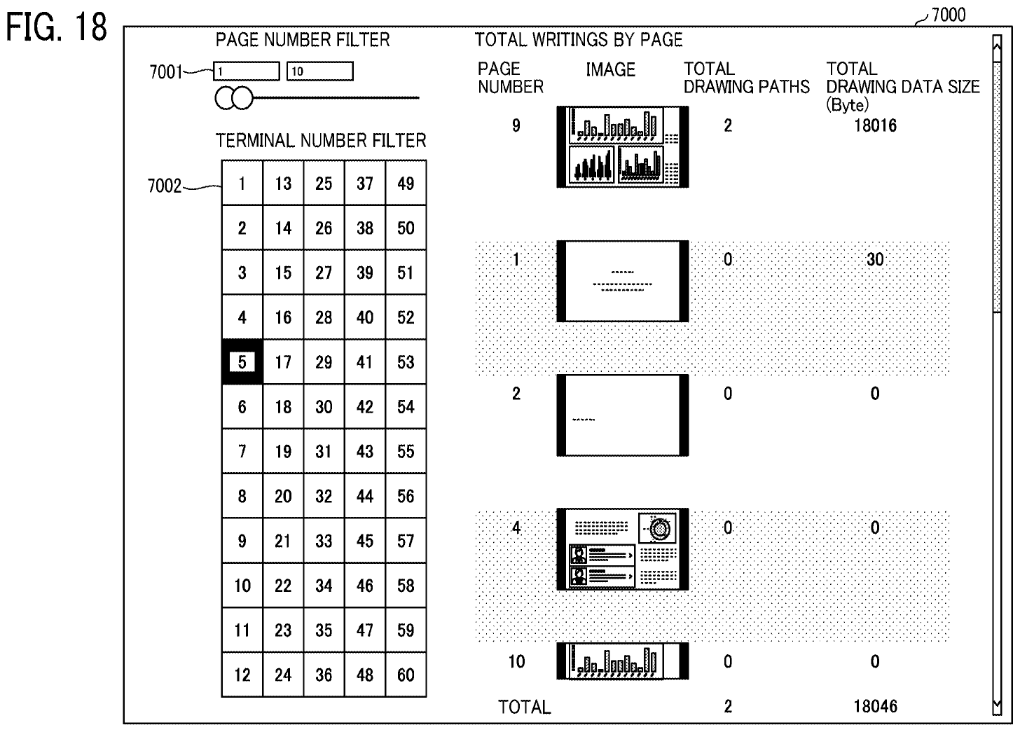

In response to pressing of the analysis result button 5040 on the personal portal screen 5000, the result display control unit 72 of the content management server 6 displays, on the personal terminal 2 for which the analysis result button 5040 has been pressed, the result display screen 7000 of the meeting corresponding to the pressed analysis result button 5040 as illustrated in FIG. 17 or 18. In alternative to pressing of the analysis result button 5040 of the personal portal screen 5000, the result display control unit 72 of the content management server 6 may display the result display screen 7000 as illustrated in FIG. 17 or 18, in response to an instruction from the organizer via an analysis tool.

FIGS. 17 and 18 are views illustrating display examples of the result display screen. The result display screen 7000 of FIGS. 17 and 18 each include a page number filter 7001 that allows the user to select a capture image subjected to analyzing the degree of interest by page number, and a terminal number filter 7002 that allows the user to select a participant subjected to analyzing the degree of interest by terminal number of the personal terminal 2.

For example, in the result display screen 7000 of FIG. 17, the page number filter 7001 is used to select page numbers “1” to “10” of the capture image subjected to analyzing the degree of interest. Further, the terminal number filter 7002 is used to select the terminal numbers “1” to “10” of the personal terminals 2 of participants subjected to analyzing the degree of interest. As an example of the analysis result of the degree of interest of the participants operating the personal terminals 2 having the terminal numbers “1” to “10” for the captured images having the page numbers “1” to “10”, the result display screen 7000 of FIG. 17 displays information on “Page with high volume of writings (KB) per terminal”, information on “Rank in writings (KB) per terminal”, information on “Terminals with high volume of total writings (KB)”, and information on “Terminal with high volume of total writings (number of paths)”.

The result display screen 7000 of FIG. 17 displays the analysis result of the degree of interest of each participant on each capture image. This analysis result may be used by the organizer of the meeting to know the degree of user's interest on a particular topic in the meeting.

For example, in the result display screen 7000 of FIG. 18, the page number filter 7001 is used to select page numbers “1” to “10” of the capture image subjected to analyzing the degree of interest. Further, the terminal number filter 7002 is used to select the terminal number “5” of the personal terminals 2 of the participant subjected to analyzing the degree of interest.

The result display screen 7000 of FIG. 18 describes an example of the analysis result of the degree of interest of the participant who operates the personal terminal 2 with the terminal number “5” on the capture images with the page numbers “1” to “10”. For example, the result display screen 7000 of FIG. 18 displays, as an example of the analysis result, information on “total writings by page”.

The information on “total writings by page” in FIG. 18 displays information on capture images, such that pages with higher total writings are arranged at top. Various information for display include information on “page number”, “image”, “total drawing paths” and “total drawing data size (Byte)”.

The result display screen 7000 of FIG. 18 displays the analysis result of the degree of interest of each participant on each capture image. This analysis result may be used by the organizer of the meeting to know the degree of user's interest on a particular topic in the meeting. For example, the organizer of the meeting is able to select a particular participant to have information on the degree of his or her interest on the capture image, for example, to find out whether there is any capture image (a particular page of the capture image) that the participant is mostly interested in.

The information sharing system of the present embodiment is able to present information, which may be used by the meeting organizer, to estimate the degree of interest of each participant on the capture image in the meeting.

### Second Embodiment

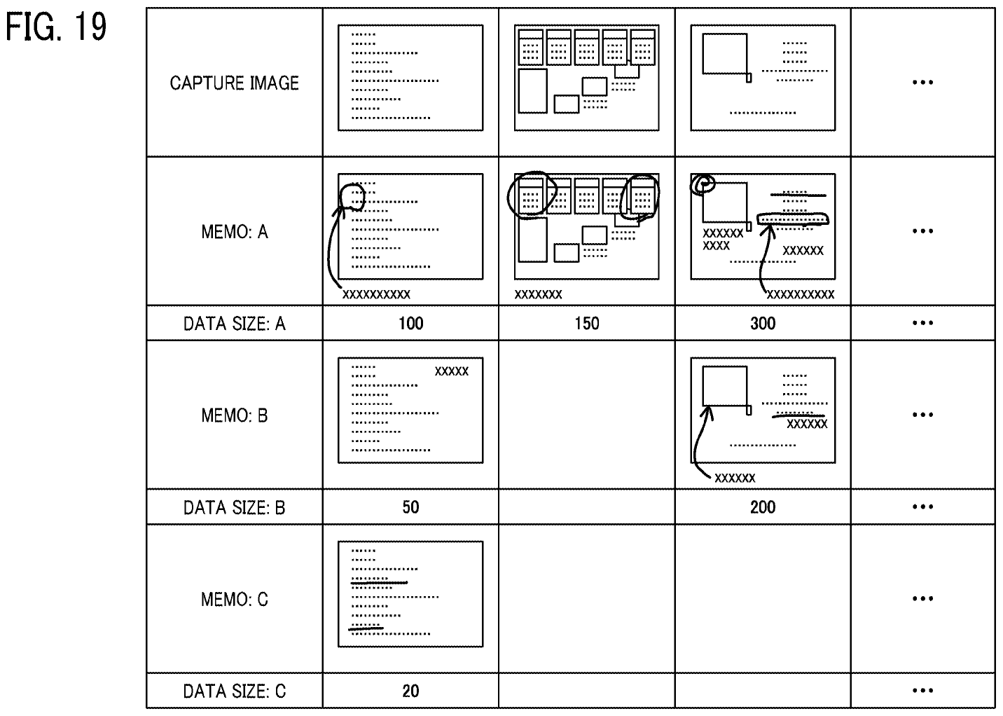

In the first embodiment, it is assumed that the same capture image is distributed to all participants of the meeting. The result display screen 7000 of any of figures may be displayed, in another example case in which the participant issues a capture shooting request. When the participant issues a capture shooing request of a capture image by himself/herself, a number of capture images to be taken may differ between users as illustrated in FIG. 19. Accordingly, the information sharing system needs to determine which one of the capture images is the same.

FIG. 19 is a diagram illustrating an example of a capture image and a memo written on the capture image or in a margin of the capture image. When the participant issues a capture shooing request of a capture image by himself/herself, a number of capture images to be taken may differ between users as illustrated in FIG. 19. In the result display screen of the second embodiment, any capture image that is not captured by the participant is not displayed. For example, if there is any page that is not captured, a space for such page is displayed as blank. In another example, only pages that have been captured may be displayed without such blank space.

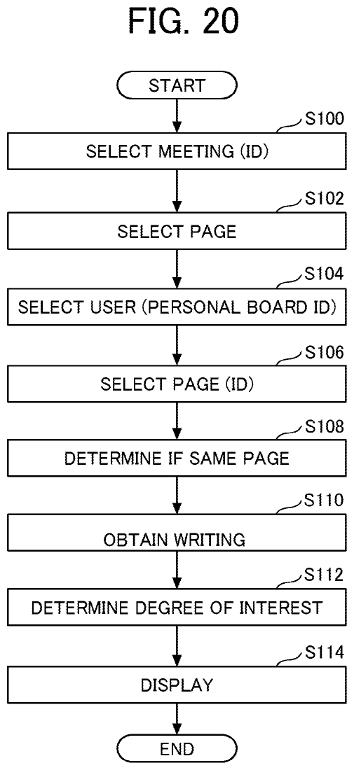

FIG. 20 is a flowchart of an example of a process of displaying a result display screen when the number of capture images differs between participants. The organizer of the meeting selects a capture image used in the meeting, to be subjected to analyzing of the degree of user's interest at S100 to S102, using the personal terminal 2.

At S100, the acceptance unit 22 of the personal terminal 2 receives selection by the organizer on a particular meeting, for example, by detecting the selected analysis result button 5040 of FIG. 16. The content management server 6 receives information on the selected analysis result button 5040, and transmits screen data for display to the personal terminal 2. The display control unit 24 controls a display of the personal terminal 2 to display a screen substantially similar to the screen illustrated in FIG. 17 or 18.

At S102, the acceptance unit 22 of the personal terminal 2 receives selection by the organizer on a particular page, for example, by detecting the input numbers on the page number filter 7001 of FIG. 17 or 18. The content management server 6 receives information on the selected page(s) of capture image.

At S104, the result display control unit 72 refers to the degree of interest management DB 6005 to select the participant, one by one, using the personal board ID of each participant in the meeting, and obtain page IDs of capture images corresponding to the personal board ID of the selected participant.

At S106, the result display control unit 72 further selects one page ID, out of the obtained page IDs of capture images for the selected participant.

If the selected page ID of capture images at S106 is the same as the selected page of capture image at S102, the operation of S110 is performed on that selected page of capture image.

At S110, the result display control unit 72 acquires information on writings (for example, amount of memo) of the capture image with the page number selected at S102 from the degree of interest management DB 6005.

S104 to S110 are performed for each user for each page of capture image.

At S112, the result display control unit 72 determines the degree of user's interest on the capture image from information on the memo amount of each participant on the selected capture image selected at 5102, in a substantially similar manner as described above in the first embodiment. At S114, the result display control unit 72 displays the result of determination on a result display screen.

Alternatively, the result display control unit 72 may display, on the result display screen, information on the amount of memo written by each participant on the selected page of captured image, to be used for determining the degree of user's interest, without S112.

### OTHER EMBODIMENTS

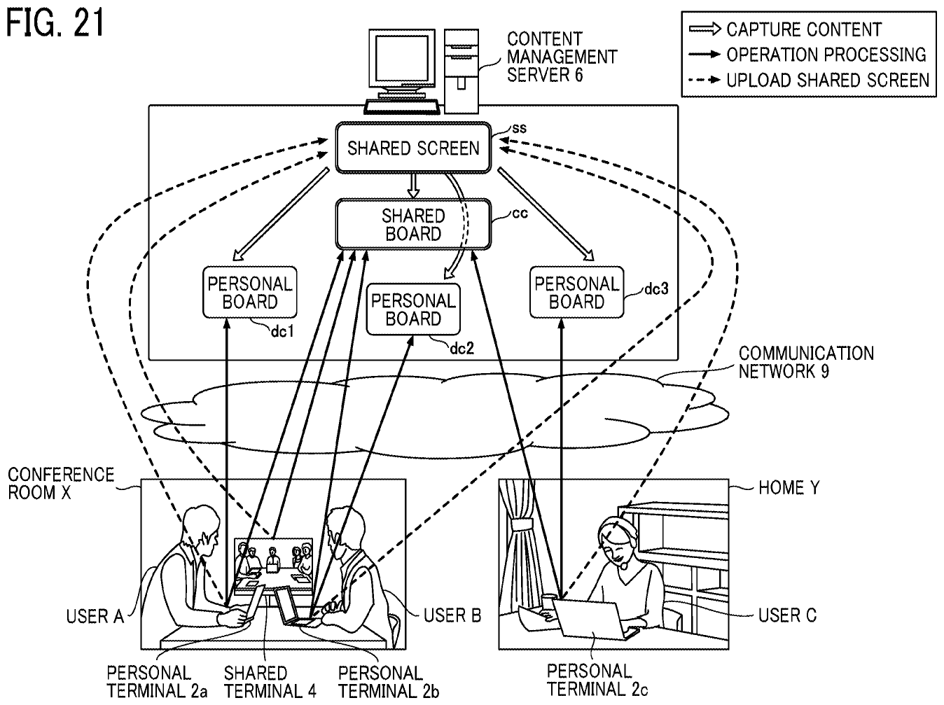

Further, the information sharing system illustrated in FIG. 1 is one example, and the embodiments are not limited thereto. In another example, the information sharing system may have a configuration as illustrated in FIG. 21. FIG. 21 is a schematic diagram illustrating an overview of the information sharing system used in a meeting being conducted, according to the present embodiment. FIG. 21 illustrates a case in which the user A and the user B who are in the conference room X of a company and the user C who is at home Y are conducting a remote meeting by using the information sharing system. The user A uses the personal terminal 2a in the conference room X, and the user B uses the personal terminal 2b in the conference room X. On the other hand, the user C uses the personal terminal 2c at the home Y.

Further, a shared terminal 4 that can be shared by multiple users is provided in the meeting room X. The shared terminal 4 is a computer that multiple users can use together and whose screen is viewed by the multiple users. Examples of the shared terminal 4 includes, but not limited to a projector (PJ), an interactive whiteboard (IWB), a digital signage, a display to which a stick PC is connected. The IWB is a whiteboard having an electronic whiteboard function having mutual communication capability. The shared terminal 4 is an example of a communication terminal (or an information processing terminal). The shared terminal 4 is communicable with the content management server 6 through the communication network 9 such as the Internet.

The content management server 6 is a computer functioning as a web server (or HTTP server) that stores and manages data of contents to be transmitted to the personal terminal 2 and the shared terminal 4.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. For example, the information sharing system according to the embodiments can be used in the following situations.

In general seminars, customers correspond to the attendees of the embodiments, and a sales person corresponds to the presenter or the organizer of the embodiments. Information on the degree of interest of each customer can be obtained by the sales person, for example, to see if any customer has interests. When the information sharing system is used in schools, students correspond to the attendees of the embodiments, and a teacher correspond to the presenter or the organizer of the embodiments. Information on the degree of interest of each student can be obtained by the teacher, for example, to see if each student is focused. In general meetings, employees correspond to the attendees of the embodiments, and management corresponds to the presenter or organizer of the embodiments. Information on the degree of interest of each employee can be obtained by the management, for example, to see if each employee is engaged.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), and field programmable gate array (FPGA), and conventional circuit components arranged to perform the recited functions.

1. An information processing apparatus comprising circuitry configured to:
cause a web browser of each of a plurality of communication terminals to display a web page including one or more images of a shared screen to be shared by the plurality of communication terminals;
for each user of a plurality of users of the plurality of communication terminals, quantify writing content written by the user at the communication terminal with respect to at least one image of the shared screen into numerical data of the writing content; and
output information based on the numerical data of the writing content for display.

2. The information processing apparatus of claim 1,
wherein the circuitry quantifies the writing content into the numerical data based on at least one of a number of lines drawn by the user, a number of marks written by the user, a number of characters written or input by the user, and an amount of the writing content.

3. The information processing apparatus of claim 1,
wherein the numerical data of the writing content is generated for each of the plurality of communication terminals and for each of the one or more images of the shared screen, and
wherein the circuitry is configured to analyze the numerical data of the writing content for each of the plurality of communication terminals, by each image of the shared screen, to generate an analysis result of each image, and output information based on the analysis result of each image for display.

4. The information processing apparatus of claim 1,
wherein the numerical data of the writing content is generated for each of the plurality of communication terminals and for each of the one or more images of the shared screen, and
wherein the circuitry is configured to analyze the numerical data of the writing content for each image of the shared screen, for a particular user of the plurality of users of the plurality of communication terminals to generate an analysis result of the particular user, and output information based on the analysis result for the particular user for display.

5. The information processing apparatus of claim 4,
wherein the numerical data of the writing content for each image of the one or more images of the shared screen for the particular user is expressed as a numerical value, and
wherein the circuitry is configured to control the display to display the one or more images of the shared screen, such that the images with higher numerical values are displayed in higher priority.

6. The information processing apparatus of claim 1,
wherein the numerical data of the writing content is generated for each of the plurality of communication terminals, for each of the one or more images of the shared screen, and for each of the plurality of users, and
wherein the circuitry is configured to analyze the numerical data of the wiring content for each user of the plurality of users of the plurality of communication terminals, for a particular image of the one or more images of the shared screen, to generate an analysis result of the particular image, and output information based on the analysis result of the particular image for display.

7. The information processing apparatus of claim 6,
wherein the numerical data of the writing content for each user of the plurality of users for the particular image is expressed as a numerical value, and
the circuitry is configured to control the display to display the plurality of users of the plurality of terminals, such that the users with higher numerical values are displayed in higher priority.

8. The information processing apparatus of claim 1,
wherein the one or more images of the shared screen are each a capture image of the shared screen.

9. An information processing system, comprising:
the information processing apparatus of claim 1; and
a plurality of communication terminals, each communication terminal including another circuitry configured to display the web page including the one or more images of the shared screen, and transmit information on the writing content with respect to at least one image of the shared screen to the information processing apparatus.

10. The information processing system of claim 9,
wherein the another circuitry of at least one of the plurality of communication terminals is configured to display an image based on the information based on the numerical data of the writing content.

11. An information processing system comprising circuitry configured to:
control a display to display, using a web browser of each of a plurality of communication terminals, a web page including one or more images of a shared screen to be shared by the plurality of communication terminals;
for each user of a plurality of users of the plurality of communication terminals, quantify writing content written by the user at the communication terminal with respect to at least one image of the shared screen into numerical data of the writing content; and
control a display to display information based on the numerical data of the writing content.

12. An information processing method comprising:
causing a web browser of each of a plurality of communication terminals to display a web page including one or more images of a shared screen to be shared by the plurality of communication terminals;
for each user of a plurality of users of the plurality of communication terminals, quantifying writing content written by the user at the communication terminal with respect to at least one image of the shared screen into numerical data of the writing content; and
outputting information based on the numerical data of the writing content for display.
